(19) United States
(12) Patent Application Publication
(10) Pub. No.: US 2007/0056184 A1
(43) Pub. Date: Mar. 15, 2007

(54) PROCESS FOR FORMING A COATING ON VEHICLE BODY, AND SEALING-AGENT DRYING APPARATUS

(75) Inventors: Keiichi Samekawa, Sayama-shi, Siatama (JP); Yuji Itou, Sayama-shi, Saitama (JP); Hideyuki Sawaki, Sayama-shi, Saitama (JP); Minoru Suzuki, Sayama-shi, Saitama (JP); Yasuhiro Kume, Sayama-shi (JP)

Correspondence Address: RANKIN, HILL, PORTER & CLARK LLP, 4080 ERIE STREET, WILLOUGHBY, OH, 44094-7836, US

(73) Assignee: HONDA GIKEN KOGYO KABUSHIKI KAISHA, Tokyo (JP)

(21) Appl. No.: 11/551,996

(22) Filed: Oct. 23, 2006

Related U.S. Application Data
(62) Division of application No. 10/329,601, filed on Dec. 26, 2002.

(30) Foreign Application Priority Data
Dec. 28, 2001 (JP) 2001-401387

(51) Int. Cl. F26B 25/06; F26B 25/00

(52) U.S. Cl. 34/202; 34/666

(57) ABSTRACT

Sequentially carried out are: a sealing-agent applying step of applying a sealing agent to a predetermined portion of a vehicle body; a coating step of applying a coating material to the vehicle body after the sealing-agent applying step; and a baking step of baking the coating material to the vehicle body after the coating step. Further, a sealing-agent drying step of drying the sealing agent by heating only the predetermined portion of the vehicle body is carried out between the sealing-agent applying step and the coating step. Thus, the sealing agent applied partially to the vehicle body can be dried with a high thermal efficiency in the process of forming a coating on the vehicle body.

### CROSS-REFERENCE TO RELATED APPLICATION

The present application is a divisional of U.S. patent application Ser. No. 10/329601, filed Dec. 26, 2002.

### BACKGROUND OF THE INVENTION

1. Field of the Invention

The present invention relates to a process for forming a coating on a vehicle body, including a sealing-agent applying step of applying a sealing agent to a predetermined portion of the vehicle body, a coating step of applying a coating material to the vehicle body after the sealing-agent applying step, a baking step of baking the coating material applied to the vehicle body after the coating step, and to a drying apparatus for drying the sealing agent applied to the vehicle body.

2. Description of the Related Art

In an automobile manufacturing line, it is conventional that a sealing-agent applying step of applying a sealing agent such as a sealer or PVC to a predetermined portion of a vehicle body for the purposes of soundproofing, rustproofing and waterproofing; and the sealing agent is then dried before a coating step in order to prevent the dripping and displacement of the sealing agent.

Conventionally, the entire vehicle body is heated in a drying oven to dry the sealing agent. For this reason, most of a heat generated in the drying oven is wasted for heating the vehicle body, a conveyer for supporting the vehicle body and the like. As a result, the thermal efficiency for drying the sealing agent is extremely low.

### SUMMARY OF THE INVENTION

Accordingly, it is an object of the present invention to provide a process for forming a coating on a vehicle body and a sealing-agent drying apparatus, wherein a sealing agent applied to the vehicle body can be dried at a high thermal efficiency.

To achieve the above object, according to a first feature of the present invention, there is provided a process for forming a coating on a vehicle body, comprising a sealing-agent applying step of applying a sealing agent to predetermined portions of the vehicle body, a coating step of applying a coating material to the vehicle body after the sealing-agent applying step, a baking step of baking the coating material to the vehicle body after the coating step, wherein a sealing-agent drying step of drying the sealing agent by heating only the predetermined portions of the vehicle body is carried out between the sealing-agent applying step and the coating step.

The coating step corresponds to an intercoating step 5 and a topcoating step 6 in an embodiment of the present invention which will be described hereinafter.

With the first feature, the sealing agent can be dried with a high thermal efficiency, and especially the partial heating of the vehicle body suffices the drying. Therefore, a large-sized drying oven capable of accommodating the vehicle body is not required, and thus it is possible to provide a remarkable reduction in equipment cost, an enhanced space efficiency in a factory, and reduced working time.

According to a second feature of the present invention, in addition to the first feature, the sealing-agent drying step is completed when the surface of the sealing agent is cured.

With the second feature, the amount of heat consumed for drying the sealing agent on the vehicle body can be further reduced. Moreover, the sealing agent having the cured surface can be sufficiently heated to be further cured to the inside thereof at the baking step after the coating step, thereby reliably exerting intended functions.

According to a third feature of the present invention, there is provided an apparatus for drying a sealing agent on a vehicle body, comprising a drying station into which a vehicle body having a sealing agent applied to predetermined portions thereof is transported, drying robots which are placed in the drying station and provided with working arms having drive sections taught the predetermined portions of the vehicle body, respectively, and heating means mounted on the working arms of the drying robots for heating only the predetermined portions.

With the third feature, while the vehicle body is being passed through the drying station, only the predetermined portion of the vehicle body having the sealing agent applied thereto can be appropriately heated to be dried with a good efficiency. Moreover, a large-sized drying oven is not required in virtue of the use of the drying robot, and thus it is possible to provide a remarkable reduction in equipment cost.

The above and other objects, features and advantages of the invention will become apparent from the following description of the preferred embodiments taken in conjunction with the accompanying drawings.

### BRIEF DESCRIPTION OF THE DRAWINGS

FIG. 1 is a diagram showing a process for forming a coating on a vehicle body according to the present invention.

FIG. 2 is a perspective view of a sealing-agent drying apparatus used at a sealing-agent drying step shown in FIG. 1.

### DESCRIPTION OF THE PREFERRED EMBODIMENTS

The present invention will now be described by way of preferred embodiments with reference to the accompanying drawings.

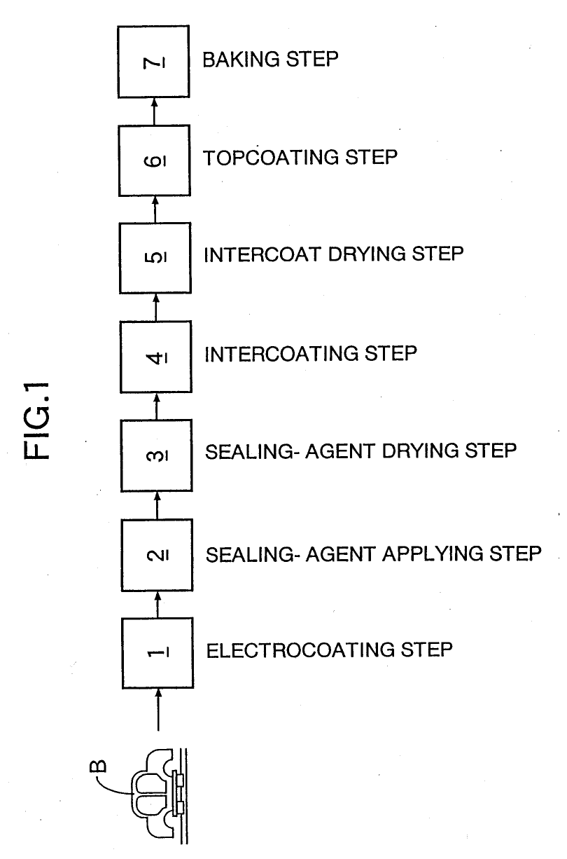

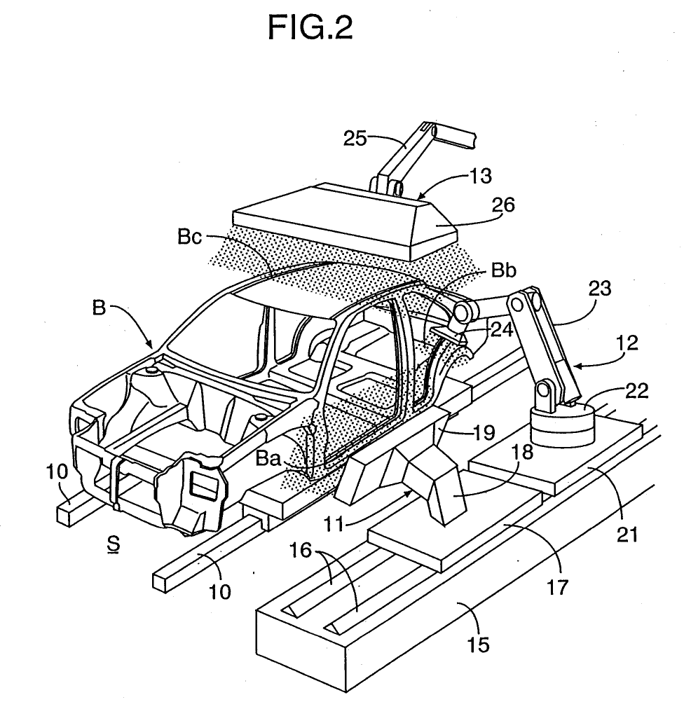

First, a process for forming a coating on a vehicle body of an automobile with reference to FIG. 1. At an electrolytic coating step 1, a base coating material is electrodeposited to a vehicle body B which has been assembled by welding various portions. Then, a sealing agent such as a sealer or PVC is applied to predetermined portions of the vehicle body B at a sealing-agent applying step 2. The predetermined portions, to which the sealing agent is applied, include, for example, an outside lower portion Ba, an inside portion Bb and a roof portion Bc in the vehicle body B, as shown in FIG. 2.

Returning to FIG. 1, after completion of the sealing-agent applying step 2, only the predetermined portions of the vehicle body B are heated to dry the sealing agent at a sealing-agent drying step 3. Such partial drying is carried out for the purpose of drying the sealing agent with a high thermal efficiency. The drying of the sealing agent is carried out to such an extent that at least the sealing agent can be prevented from dripping or being displaced while the vehicle body B is being shifted to a next step. Specifically, the drying is terminated when the surface of the sealing agent is cured. By carrying out the drying in the above manner, the consumption of heating energy can be minimized.

A test showed the following: To heat the entire vehicle body B until the sealing agent was cured to the inside thereof so as to be able to exhibit a predetermined function, in the conventional process, a drying step length of 38.5 m, a drying step time of 9 minutes and 20 seconds and an input heat amount of 16,278 Kcal per vehicle body were required; whereas to heat only the predetermined portions of the vehicle body B until the surface of the sealing agent was cured, as in the present embodiment, a drying step length of 11 m, a drying step time of 2 minutes and 20 seconds and an input heat amount of 220 Kcal per vehicle body sufficed. Therefore, according to the present invention, it is possible to enhance not only the thermal efficiency but also a space efficiency in a factory and to shorten the drying step time. In addition, a large-sized drying oven capable of accommodating a vehicle body B having a length corresponding to the drying step length of 38.5 m is required at the conventional sealing-agent drying step; whereas a relatively small-sized heating means for partially heating the vehicle body B is used at the sealing-agent drying step 3 in the present invention. Therefore, according to the present invention, a special drying oven is not required, and hence a remarkable reduction in equipment cost can be achieved.

After completion of the sealing-agent drying step 3, an intermediate coating material is applied to the vehicle body B at an intercoating step 4 and dried at intercoat drying step 5, whereby an intercoat is formed on the vehicle body B. Then, a finishing coating material is applied to the vehicle body B at a topcoating step 6 and finally subjected to baking drying at a baking step 7, whereby a finish coating is formed on the intercoat. The finish coating assumes the form of a solidified paste if the coating materials are thickly applied, or the form of a film or sheet if the coating materials are thinly applied.

The sealing agent having the surface cured at the sealing-agent drying step 3 is cured to the inside thereof by the heating at the intercoat drying step 5 and the baking step 7, and hence the sealing agent is capable of reliably exerting predetermined functions such as a waterproofing function and a soundproofing function.

A sealing-agent drying apparatus used at the sealing-agent drying step 3 will be described below with reference to FIG. 2.

The vehicle body B coated with the sealing agent is transported to a drying station S by a conveyer 10 disposed on a floor in an automobile factory. A first drying robot 11 for partially drying the outside lower portion Ba of the vehicle body B and a second drying robot 12 for partially drying the inside portion Bb of the vehicle body B are disposed in the drying station S on each of opposite sides of the conveyer 10. Only the first and second drying robots 11 and 12 on one side of the conveyer 10 are shown in FIG. 2, and the first and second drying robots 11 and 12 on the other side of the conveyer 10 are not shown in FIG. 2. A third drying robot 13 for partially heating the roof portion Bc of the vehicle body B is mounted on a ceiling of the factory.

The first robot 11 comprises a stationary base 15 placed on the floor in the drying station S, a slider 17 capable of sliding along rails 16 extending in parallel to the conveyer 10, and a working arm 18 protruding from an upper surface of the slider 17. A heating means 19 is mounted at a tip end of the working arm 18 with its heating surface facing the predetermined outside lower portion Ba of the vehicle body B. The stationary base 15 includes a drive section (not shown) for driving the slider 17 to slide along the rails 16. The drive section has been subjected to a teaching of an operating method so that the heating means 19 traces the predetermined outside lower portion Ba of the vehicle body B in response to the movement of the vehicle body B on the conveyer 10.

The second drying robot 12 comprises the stationary base 15, a slider 21 capable sliding along the rails 16 on the stationary base 15, a turn table 22 rotatably supported at an upper portion of the slider 21, and a multi-joint working arm 23 supported on the turn table 22. A heating means 24 having a relatively small heating surface is mounted at a tip end of the working arm 23. The stationary base 15 includes a drive section (not shown) for driving the slider 21 to slide along the rails 16. The slider 21 includes a drive section (not shown) for rotating the turn table 22. Each of the drive sections has been subjected to a teaching of an operating method so that the heating means 24 traces predetermined points of the inside portion Bb of the vehicle body B in response to the movement of the vehicle body B on the conveyer 10.

The third drying robot 13 also includes a multi-joint working arm 25, and a heating means 26 capable of heating a predetermined point of the roof portion Bc of the vehicle body B is mounted at a tip end of the working arm 25. A drive section (not shown) of the working arm 25 has been taught an operating method, so that the heating means 26 tracks the predetermined point of the roof portion Bc of the vehicle body B in response to the movement of the vehicle body B on the conveyer 10.

Therefore, while the vehicle body B is being passed through the drying station S, the sealing agent on the outside lower portion Ba of the vehicle body B, the sealing agent on a floor within the vehicle body B and on an inner wall of an engine room and the sealing agent on the roof portion of the vehicle body B are dried with a good efficiency by the first drying robot 11, the second drying robot 12 and the third drying robot 13, respectively, to thereby dry the sealing agent in a relatively short time. Moreover, a large-sized drying oven is not required in virtue of the use of the drying robots 11, 12 and 13, which can provide a remarkable reduction in equipment cost.

The heating means 19, 24 and 26 may be any of a hot air type, an infrared ray type, a light beam type, a laser type, a far infrared ray/hot air type, a far infrared ray/microwave type, an ultrasonic type and a high frequency wave type.

Lid-like members such as a bonnet and doors have been removed from the vehicle body B at the drying step in the illustrated embodiment (FIG. 2), but when the sealing agent has been applied to the lid-like members, the drying step may be carried out in a state in which the lid-like members are mounted to the vehicle body B.

The present invention is not limited to the above-described embodiments, and various modifications in design may be made without departing from the spirit and scope of the invention defined in the claims.

What is claimed is:

1. An apparatus for drying a sealing agent on a vehicle body, comprising:
a drying station into which a vehicle body having a sealing agent applied to a predetermined portion thereof is transported;
a drying robot which is placed in the drying station and provided with a working arm, the working arm having a drive section which has been taught the predetermined portion of the vehicle body; and
heating means mounted on the working arm of the drying robot for heating only the predetermined portion.
